(19) United States
(12) Patent Application Publication
(10) Pub. No.: US 2013/0197842 A1
(43) Pub. Date: Aug. 1, 2013

(54) STREAMLINED PARTS APPROVAL PROCESS

(71) Applicant: Charly Ugorji, Peoria, IL (US)

(72) Inventor: Charly Ugorji, Peoria, IL (US)

(73) Assignee: CATERPILLAR INC.

(21) Appl. No.: 13/469,699

(22) Filed: May 11, 2012

Related U.S. Application Data
(60) Provisional application No. 61/593,101, filed on Jan. 31, 2012.

(51) Int. Cl. G06F 19/00

(52) U.S. Cl. 702/82

(57) ABSTRACT

A method for streamlining a production parts approval process is disclosed. The method includes receiving a master file. The master file includes nominals and tolerances of a production part for a plurality of dimensions of the production part. The method further includes receiving a measurement results file containing results of measurements taken on the production part. The method also includes creating a verification report. The verification report includes a summary of a comparison of the measurement results file with the master file.

This application claims priority from the provisional application, entitled “Streamlined Parts Approval Process,” Ser. No. 61/593,101, filed on Jan. 31, 2012.

### TECHNICAL FIELD

This disclosure relates generally to a production parts approval process and, more particularly, to systems, methods, and computer readable media for streamlining a production parts approval process.

### BACKGROUND

When manufacturing parts for various applications, it is important to verify that the parts conform to the desired specifications. One process for verifying that parts being produced have been manufactured according to specification is a production parts approval process. In a traditional production parts approval process (PPAP), a customer sends an engineering drawing or print of the requested part to a supplier. The supplier manufactures the part based on the print and then tests the parts to ensure dimensional conformance with the print.

To test the parts, an operator may review the engineering drawing and perform measurements of the parts based on the dimensions, nominals and tolerances found in the engineering drawing. This can be done, for example, by manually entering the dimensions, nominals and tolerances from the engineering drawing into a testing machine or measuring device that performs the measurements. After measuring the requested part dimensions, the testing machine may store the measurement results in a data format native to the testing machine.

A software program may then convert the measurement results into a more universal format and import the results into a user friendly spreadsheet format. The spreadsheet may include rows for each dimension of the part that was measured, columns for nominals, tolerances, test results, and a pass/fail assessment for the part based on the test result of the measured dimension. The results of the testing may be reviewed and certified.

However, because the spreadsheet relies on data entered into the testing machine, an operator will not be notified of measurements that should have been taken but were not taken, or of nominals or tolerances that were incorrectly entered. If measurements were not taken, or if incorrect nominals or tolerances were entered, a production part may be incorrectly certified as conforming to the required specifications, or incorrectly identified as failing to conform. Further, each part may include hundreds of dimensions, and the results for each part may be several pages or more, making it difficult to quickly identify failure points within the results. Because a customer or supplier may be required to review dimensional test results for thousands of parts, where each part may include hundreds of dimensions, the review of the dimensional test results may be extremely time consuming, which may lead to a less than thorough review of the results.

Accordingly, the disclosed systems, methods, and computer readable media for streamlining a production parts approval process are directed at alleviating one or more of the disadvantages set forth above.

### SUMMARY

In accordance with one aspect, the present disclosure is directed toward a method for streamlining a production parts approval process. The method includes receiving a master file. The master file includes nominals and tolerances of a production part for a plurality of dimensions of the production part. The method further includes receiving a measurement results file containing results of measurements taken on the production part. The method also includes creating a verification report. The verification report includes a summary of a comparison of the measurement results file with the master file.

According to another aspect, the present disclosure is directed toward a system for streamlining a production parts approval process. The system includes a measuring device that measures dimensions of a production part, and a computing system including a central processing unit. The central processing unit is configured to receive a master file. The master file includes nominals and tolerances of a production part for a plurality of dimensions of the production part. The central processing unit is further configured to receive a measurement results file from the measuring device. The measurements results file contains results of measurements taken on the production part. The central processing unit is further configured to create a verification report. The verification report includes a summary of a comparison of the measurement results file with the master file.

### BRIEF DESCRIPTION OF THE DRAWINGS

FIG. 1 is a diagrammatic illustration of an exemplary disclosed system;

FIG. 2 is a diagrammatic illustration of an exemplary disclosed verification report;

FIG. 3 is a flowchart illustrating an exemplary disclosed method; and

FIG. 4 is a block illustration of an exemplary disclosed computer system.

### DETAILED DESCRIPTION

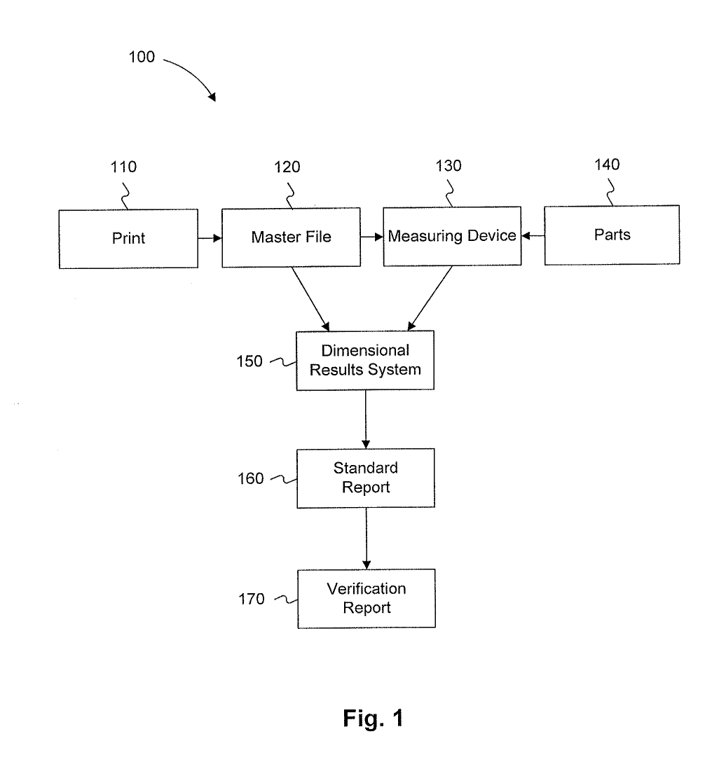

FIG. 1 illustrates an exemplary system 100 for streamlining a production parts approval process according to embodiments of the disclosure. The system 100 may include a print 110 that represents a part to be manufactured. The print 110 may be a two or three dimensional wireframe representation of the part, and include dimensions of the part, nominals and tolerances. The print 110 may include a single sheet or multiple sheets, and may include a bill of materials. The dimensions identify features of the part, and may include linear measurements, angular measurements, radial measurements, diameter measurements, weld measurements, surface measurements, or any other pertinent design or process measurements or characteristics. For example, if the part is a hex nut, dimensions may include the basic major diameter of the thread, the width across flats, the width across corners, and the thickness or height of the hex nut. The nominal for each of the dimensions is the ideal measurement for the dimension, and the tolerance determines the acceptable deviation from the nominal.

The print 110 may be obtained by converting an engineering drawing created in any one of commercially available engineering drawing programs, such as CATIA, SolidWorks, Pro/ENGINEER, etc., into a specific format. The print 110 may alternatively be obtained directly from an engineering drawing program in a format native to the program. For example, in one embodiment, the print 110 may be a TIFF file format representation of the part. By selecting a specific file format for the print, the dimensions may be exported into a uniform format, in this example, a TIFF file, regardless of which engineering design program is used to design the part. Embodiments of the disclosure are not limited to TIFF files for the print 110, however, and any suitable graphic representation may be used for the print 110.

The system 100 may also include a master file 120 that stores nominal and tolerance values for dimensions of the part as found on the print 110. The master file 120 may also store information from a bill of materials contained in the print 110. The master file 120 may be stored in a database or other storage medium, such as a volatile or non-volatile, magnetic, semiconductor, tape, optical, removable, non-removable, or other type of computer-readable medium used as a storage device. The master file 120 may be stored as an encrypted file, and may include a digital signature or other self-authenticating means.

The master file 120 may be generated by importing the print 110 and extracting the dimensions, nominals and tolerances for the part. Generating the master file 120 may also include extracting the bill of materials from the print 110 when present. The master file 120 may be generated using a known computer system that includes at least a processor and memory. By directly importing the dimensions, nominals and tolerances for the part from the print 110, the accuracy of the master file 120 can be enhanced.

The system 100 may also include one or more measuring devices 130 that measure dimensions of the part. The measuring devices 130 may be any of known measuring devices, such as a coordinate measuring machine, tool measuring machine, tactile measuring machine, etc. The embodiments of the disclosure are not limited to specific measuring devices.

Parts 140 may be manufactured by a supplier based on the print 110 or an engineering drawing from which the print 110 was derived. The measuring devices 130 may be loaded with information about the parts 140 from the master file 120. In one embodiment, the master file 120 may be uploaded directly to the measuring devices 130. In another embodiment, the information in the master file 120 may be manually entered into the measuring devices 130.

The measuring devices 130 may measure one or more samples selected from the manufactured parts 140. The measuring devices 130 may measure each of the dimensions found in the master file 120 based on the print 110. Although the print 110 or the master file 120 may specify an order to the dimensions, the measuring devices 130 may rearrange the order of the dimensions when performing the measurements to more efficiently measure each of the dimensions.

The measuring devices 130 may store results of the measurements. The results may be stored internally on the measuring devices 130 or may be stored externally on a separate storage device. The results may be stored in a data format that is native to the measuring devices 130, or may be converted to another format and stored in the other format. An example of another format is any of commercially available spreadsheet program formats.

The system 100 may also include a dimensional results system 150 that may receive as input the master file 120 and measuring results from the measuring devices 130. The dimensional results system 150 may be embodied using a known computer system that includes at least a processor and memory. If the master file 120 is encrypted, the dimensional results system 150 will decrypt the master file as necessary. Similarly, if the master file 120 incorporates a form of self-authentication such as a digital signature, the dimensional results system 150 may authenticate the master file 120. The dimensional results system 150 may also convert the format of the measuring results from the measuring devices 130 as necessary to so that the data may be evaluated and used. The dimensional results system 150 may combine the data from the master file 120 and the measuring results from the measuring devices 130. To facilitate the combination of data from the master file 120 with the measuring results from the measuring devices 130, both sets of data may be converted into a common file format, for example, an XML data format.

The dimensional results system 150 may generate a standard report 160 detailing the results of the part measurements. In one embodiment, the standard report 160 may be a spreadsheet including a column listing each dimension that was measured, a column listing the nominal value for the measured dimension, one or more columns listing the tolerance for the measured dimension, one or more columns for measured values of the dimension on the sample parts, and a column listing whether the tested parts are within the tolerance of the nominal for the measured dimension.

The dimensional results system 150 may also generate a verification report 170. The verification report may be a modification of the standard report 160, or may be a separate report. The verification report 170 may include each of the features of the standard report 160, and may additionally include a summary of the standard report 160. In one embodiment, the summary is a single page report. A single page may refer, for example, to a single 8.5″ by 11″ printed sheet, an A4 sized printed sheet, or a single computer display screen. The summary may include a listing of any errors or mismatches detected. For example, the summary may include a line for each dimension where the measured samples were outside the tolerance. The summary may also include a line for each dimension where the nominal or tolerance entered into the measuring devices 130 does not match the nominal or tolerance in the master file 120 for the particular dimension. The summary may also include a line for each dimension included in the master file 120 that was not tested, or for any dimension that was measured but is not included in the master file 120.

The summary may also include a visual pass/fail indication for one or more of a features verification, a nominals verification, a tolerances verification, and a results verification. The features verification may indicate whether all of the dimensions in the print 110 have been measured and reported. The nominals verification may indicate whether all of the nominals entered into the testing devices 130 match the corresponding nominals in the master file 120. The tolerances verification may indicate whether all of the tolerances entered into the testing devices 130 match the corresponding tolerances in the master file 120. The results verification may indicate whether all of the measured sample parts were within tolerance for all of the dimensions.

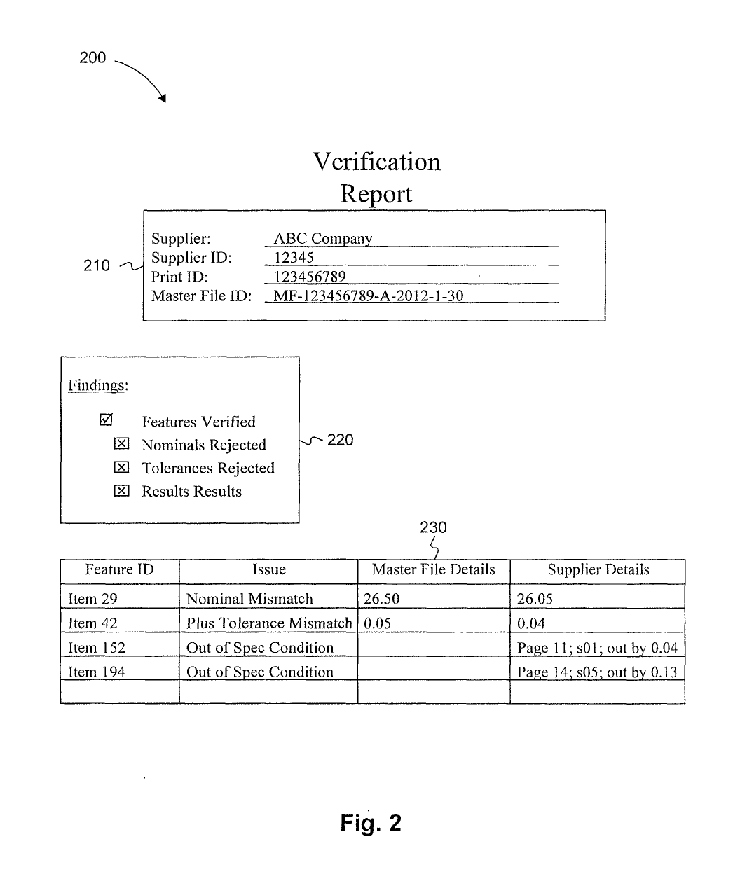

FIG. 2 illustrates an exemplary verification report 200 that may be generated by the dimensional results system 150. The verification report 200 may include a header 210 that contains identifying information, such as the supplier name, supplier ID, print ID, and master file ID. The header 210 may also include other information, such as a standard report ID, a revision number, or other information relating to the verification report.

The verification report 200 may also include a findings section 220 that provides a summary of the verification. In the exemplary verification report 200, a check mark may indicate that the verification passed, and an “x” may indicate that the verification failed. In the exemplary verification report 200, all of the dimensions in the print (as found in the master file) have been measured and reported, so the features verification is indicated as a “pass”. In the exemplary verification report 200, however, discrepancies were found between the nominals and tolerances in the master file and the nominals and tolerances reported out from the measuring devices, so the nominals verification and the tolerances verification are indicated as “fails”. In the exemplary verification report 200, the results reported from the measuring devices for at least one sample were not within tolerance, so the results verification is also indicated as a “fail”.

The verification report 200 may include a findings detail section 230 that specifically identifies and summarizes any errors or mismatches detected during the verification process. If no errors or mismatches are detected, the verification report 200 may omit the findings detail section 230, or include a brief statement that no errors or mismatches were detected. In the exemplary verification report 200, four errors or mismatches were detected. The first mismatch was detected with respect to dimension item 29, where the nominal in the master file did not match the nominal entered into the measuring devices and subsequently reported out of the measuring devices. That is, the supplier details for the nominal did not match the master file details. The second mismatch was detected with respect to dimension item 42, where the plus tolerance in the master file did not match the plus tolerance entered into the measuring devices and subsequently reported out of the measuring devices. That is, the supplier details for the plus tolerance did not match the master file details. The supplier details are the details that the supplier received from the measuring devices, as may be found in the standard report 160. The third error was detected with respect to dimension item 152, where the dimension of at least one of the measured sample parts in the master file did not fall within the entered tolerance range. That is, the part did not conform to the print specifications with respect to dimension item 152. The fourth error was detected with respect to dimension item 194, where the dimension of at least one of the measured sample parts in the master file did not fall within the entered tolerance range. That is, the part did not conform to the print specifications with respect to dimension item 194. If detected, the findings detail section 230 may also include entries for dimensions or features included in the master file that were not measured, or for any dimension that was measured but that is not included in the master file.

By including only row entries where errors or mismatches were detected, a simple summary may be achieved that can be reviewed to quickly understand the results of the part measurements. This may significantly reduce the time required to verify the measurement results of the measuring devices.

### INDUSTRIAL APPLICABILITY

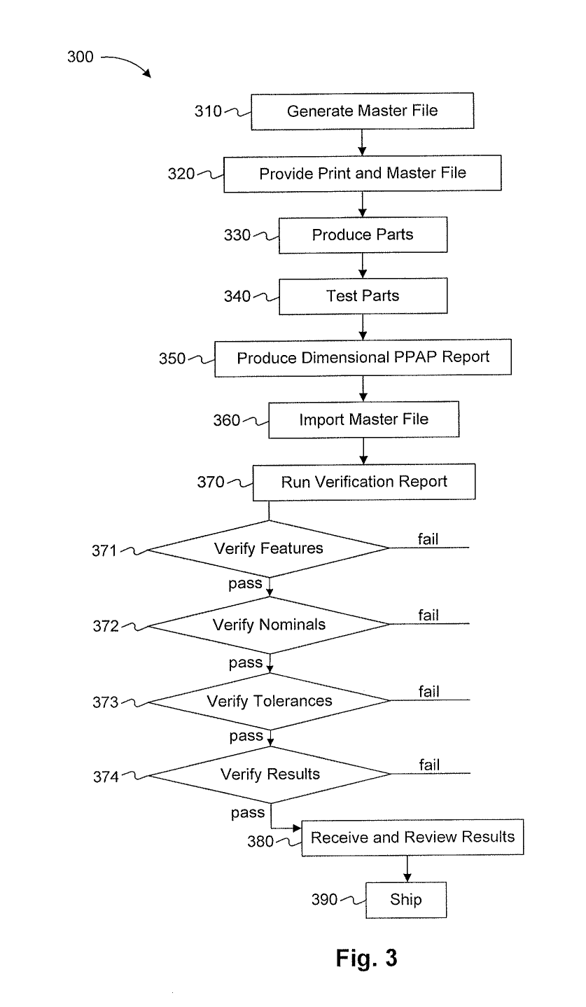

The disclosed systems, methods, and computer readable media for streamlining a production parts approval process may be used for streamlining any parts approval process. The parts approval process may be part of a broader advanced product quality planning (APQP) framework. FIG. 3 illustrates an exemplary method 300 for streamlining a production parts approval process. The production parts approval process may be used, for example, when a customer seeks to purchase a part from a supplier. The production parts approval process helps ensure that the purchased parts will conform to the desired specifications. Streamlining the production parts approval process as disclosed in embodiments of this disclosure may reduce or eliminate errors caused by shipping parts outside of specification, and can significantly reduce the time required to ensure conformance with the desired specifications.

In step 310, a master file may be generated. The master file may include dimensions, nominals for the dimensions, and tolerances for the dimensions for a desired production part. The master file may be generated by importing a print of the part and extracting the dimensions, nominals and tolerances for the part, where the print has been converted from an engineering drawing into a standard format compatible with the master file. The master file may be in the form of a spreadsheet.

In step 320, the customer may provide the print and the master file to the supplier. As used in this disclosure, the customer and supplier may be separate entities, may be different business groups within a single entity, or may be the same entity. The term customer refers to the entity requesting and receiving the production parts, and the term supplier refers to the entity manufacturing and testing the parts. Although the exemplary method 300 illustrated in FIG. 3 may refer to specific entities as performing specific tasks, the tasks may be performed by either party or other parties as may be necessary or desired.

In step 330, the supplier may manufacture the parts based on the print and master file provided by the customer. In an alternative embodiment, the supplier may otherwise procure parts satisfying the requirements in the print and the master file provided by the customer.

In step 340, the supplier may test the parts, or a subset of the parts. The supplier may test the parts by measuring each of the dimensions in the print or master file to ensure that the parts fall within the acceptable tolerance identified in the print or master file. The required dimensional measurements may be imported from the master file into the measuring devices, or an operator may enter each of the required dimensional measurements, along with the corresponding nominals and tolerances. The results of the measurements may be stored, for example, on the measuring devices that measured the parts, or on any other computer readable storage medium such as RAM or ROM, or a magnetic or optical storage device. The results may be stored in a data format that is native to the measuring devices, or may be converted to another format and stored in the other format. For example, where the master file is an XML file, the results may also be formatted into an XML file to enhance the interoperability of the data.

In step 350, the supplier may produce a report based on the test results obtained from the testing in step 340. The report may be a dimensional production parts approval process report (dimensional PPAP report), similar to the standard report 160 illustrated in FIG. 1. The report may be a spreadsheet including a column listing each dimension of the part that was measured, a column listing the nominal value for each measured dimension, one or more columns listing tolerances for each measured dimension, one or more columns for measured values of the dimension on the sample parts, and a column listing whether the tested parts are within the tolerance of the nominal for the measured dimension.

The report may be generated by an operator interfacing with a graphical user interface (GUI) specifically designed to assist in the creation of dimensional PPAP reports. The GUI may be displayed on a standard display connected to a computing system, and may include options for importing the test results from the measuring devices, validating the test results, importing the master file, and verifying the test results with the master file.

After importing and displaying the test results, an operator may import the associated master file by selecting an “import master file” option within the GUI in step 360. If necessary, the computing system may decrypt and authenticate the master file before importing the master file into the dimensional PPAP report. In other embodiments, the master file may be imported before the test results are imported, or both the master file and the test results may be imported at the same time. After importing the master file, data from the master file may be used to augment the dimensional PPAP report.

In step 370, the operator may select a “run verification report” option within the GUI to run the verification report on the test results and the master file. The computing system may generate the verification report by comparing the test results from the measuring devices with the master file. The verification report may include an indication whether any errors or discrepancies were found, and a summary of any errors or discrepancies found during one or more of the feature verification, the nominals verification, the tolerance verification, or the results verification.

In step 371, the computing system may verify the part features listed in the dimensional PPAP report by verifying that each dimension in the master file was tested or measured for the sample parts, and may also determine whether any additional dimensions were tested that are not in the master file. If any discrepancies exist between the master file and the reported test results, the verification report may indicate that the features verification failed, and specifically note the failure. For example, if a dimension in the master file was not measured during testing, the verification report may indicate the dimension, along with the nominal and tolerances for the untested dimension.

If the features verification fails, appropriate corrective action may be taken. For example, a measuring device operator may be notified of the untested dimensions, and the operator may measure the untested dimensions, as in step 340. In one embodiment, operation of the method may return to step 340 to complete the required testing and measuring, and proceed from step 340 as described above.

Because the verification process can be quickly automatically performed, the sample part or parts may still be in the measuring devices, and the operator may input the untested dimensions into the measuring devices and run the additional tests or measurements. This may save considerable time by eliminating the need to set up the part(s) in the measuring devices again, or track down parts which may have been sent on to another step of processing, for example, preparation for shipment.

In step 371, if the features verification passes, the verification report may indicate the pass, and operation of the method may then proceed to step 372.

In step 372, the computing system may verify the nominals in the dimensional PPAP report by verifying that each nominal in the master file matches the corresponding nominal provided to the measuring devices and in the dimensional PPAP report. If any discrepancies exist between the master file and the nominals in the dimensional PPAP report, the verification report may indicate that the nominals verification failed, and specifically note the failure. For example, both the value of the nominal in the master file and the value of the nominal recorded in the dimensional PPAP report may be listed on the verification report.

If the nominals verification fails, appropriate corrective action may be taken. For example, a measuring device operator may be notified of the incorrectly entered nominal, and the operator may run the testing or measuring again for the specific dimension using the correct nominal, as in step 340. In one embodiment, operation of the method may return to step 340 to run the testing or measuring again for the specific dimension using the correct nominal, and proceed from step 340 as described above.

In another embodiment, if a nominal on the dimensional PPAP report does not match the nominal in the master file, the nominal in the dimensional PPAP report may be updated to the nominal in the master file. In this embodiment, if the sample part satisfies the nominal and tolerances in the master file, there may be no need to rerun the measuring of the part, as the error may be considered only a clerical error.

If the nominals verification passes in step 372, the verification report may indicate the pass, and operation of the method may then proceed to step 373.

In step 373, the computing system may verify the tolerances in the dimensional PPAP report by verifying that each tolerance in the master file matches the corresponding tolerance provided to the measuring devices and in the dimensional PPAP report. If any discrepancies exist between the master file and the tolerances in the dimensional PPAP report, the verification report may indicate that the tolerances verification failed, and specifically note the failure. For example, both the values of the tolerances in the master file and the values of the tolerances recorded in the dimensional PPAP report may be listed on the verification report.

If the tolerances verification fails, appropriate corrective action may be taken. For example, a measuring device operator may be notified of the incorrectly entered tolerances, and the operator may run the testing or measuring again for the specific dimension using the correct tolerances, as in step 340. In one embodiment, operation of the method may return to step 340 to run the testing or measuring again for the specific dimension using the correct tolerances, and proceed from step 340 as described above.

In another embodiment, if tolerances on the dimensional PPAP report do not match the tolerances in the master file, the tolerances in the dimensional PPAP report may be updated to reflect the tolerances in the master file. In this embodiment, if the sample parts satisfy the nominal and tolerances in the master file, there may be no need to rerun the measuring of the part, as the error may be considered only a clerical error.

If the tolerances verification passes in step 373, the verification report may indicate the pass, and operation of the method may proceed to step 374.

In step 374, the computing system may verify the results of the parts testing by verifying that each dimension of each sample part tested by the measuring devices falls within the nominals and tolerances in the master file. If any of the measured dimensions do not fall within the nominals and tolerances in the master file, the verification report may indicate that the results verification failed, and specifically note the failure. For example, the dimension, nominal, tolerances, and measured values of the sample part that is outside the tolerance may be listed on the verification report.

If the results verification fails, appropriate corrective action may be taken. For example, a measuring device operator or other appropriate representative of the supplier may be notified of the failure. In one embodiment, the measuring device operator may test additional parts. In another embodiment, operation of the method may return to step 330 and the manufacturing process may be appropriately modified in view of the outside tolerance dimension and then rerun.

If the results verification passes in step 374, the verification report may indicate the pass, and operation of the method may proceed to step 380.

It should be noted that, in other embodiments, the verifications 371 to 374 may all be run prior to taking any corrective action. That is, in one embodiment, even if the verification at step 371 fails, the method may continue to step 372, or if the verification at step 372 fails, the method may still continue to step 373, or if the verification at step 373 fails, the method may still continue to step 374. In some embodiments, the verifications 371 to 374 may be run in a different order. In some embodiments, not all of the verifications 371 to 374 may be run, but a subset of the verifications 371 to 374 may be selected. For example, in one embodiment, only the results verification in step 374 may be performed. Although the verification report with only the results verification may be less detailed or thorough than a verification report with all of the verifications, such a verification report still provides a succinct summary of any failures without requiring a process control engineer or other individual to scan every single dimension and result on every page of the dimensional PPAP report, especially where there may be hundreds or thousands of dimensions for hundreds or thousands of different production parts.

In step 380, the verification report may be reviewed, for example, by one or more process control engineers. Because the verification report may be substantially shorter than the full dimensional PPAP report, for example, a single page, a process control engineer tasked with reviewing dimensional PPAP reports for a large number of different production parts may be substantially more efficient by initially reviewing only the verification reports. Then, if the verification reports indicate any irregularities or failed verifications, the process control engineer may spend more time reviewing the specific portions of the specific dimensional PPAP report for the specific production part. Thus, according to disclosed embodiments, a production parts approval process may be streamlined by expediting review and verification of production parts measurements.

The process control engineer may be an employee of the supplier, an employee of the customer, or independent of both the customer and supplier. Upon final approval by the process control engineer, operation of the method may proceed to step 390, where the production parts may be shipped to the customer. In one embodiment, the parts may be shipped after the verification report indicates that each verification or a subset of the verifications in steps 371 to 374 passed, and the review of the verification report may occur after shipment.

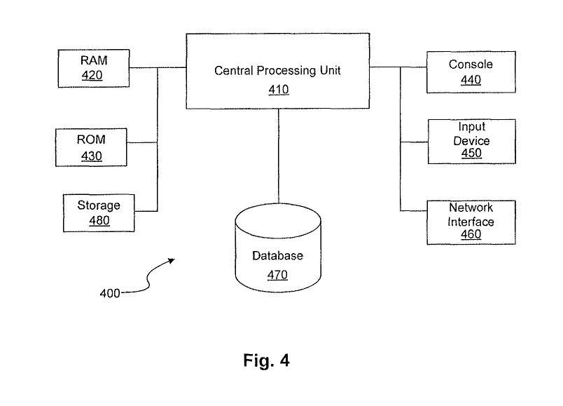

FIG. 4 illustrates an exemplary computing system 400 that may be used in embodiments of the disclosure to perform operations relating to the disclosed systems and methods for streamlining a production parts approval process. The computing system 400 may include a central processing unit (CPU) 410, a random access memory (RAM) 420, a read-only memory (ROM) 430, a console 440, an input device 450, a network interface 460, at least one database 470, and a storage 480. It is contemplated that computing system 400 may include additional, fewer, and/or different components than what is listed above. It is understood that the type and number of listed devices are exemplary and not intended to be limiting.

Storage 480 may be a non-transitory computer readable storage medium storing instructions for streamlining a production parts approval process, the instructions causing the CPU 410 to perform operations according to methods of this disclosure. In other embodiments, the instructions may be stored in RAM 420, ROM 430, database 470, or other data storage devices, and may be loaded into the CPU 410 to perform operations according to method of this disclosure.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for streamlining a production parts approval process, the method comprising:
receiving a master file, the master file including nominals and tolerances of a production part for a plurality of dimensions of the production part;
receiving a measurement results file containing results of measurements taken on the production part; and
creating a verification report, the verification report including a summary of a comparison of the measurement results file with the master file.

2. The method according to claim 1, wherein the master file and the measurement results file are combined into a dimensional report, and the verification report is created based on the dimensional report.

3. The method according to claim 1, wherein the verification report includes at least one of: (1) a feature verification; (2) a nominals verification; (3) a tolerance verification; or (4) a results verification.

4. The method according to claim 1, wherein the measurements results file includes an entry for each measured dimension of the production part, each entry including the nominal and tolerances of the dimension and the measurement results.

5. The method according to claim 4, wherein the verification report includes a summary of at least one of: (1) a feature verification; (2) a nominals verification; (3) a tolerance verification; or (4) a results verification.

6. The method according to claim 5, wherein:
the feature verification includes verifying that, for every dimension of the product part in the master file, there is a corresponding measurement result in the measurement results file;
the nominals verification includes verifying that the nominals for every dimension of the production part in the master file match the nominals for corresponding measurement results in the measurement results file;
the tolerance verification includes verifying that the tolerances for every dimension of the production part in the master file match the tolerances for corresponding measurement results in the measurement results file; and
the results verification includes verifying that the measurement results in the measurement results file for each dimension of the production part are within the tolerance of the nominal of the dimension.

7. The method according to claim 5, wherein the verification report further includes an indication whether any errors or discrepancies were found and a summary of any errors or discrepancies found during the at least one of the feature verification, the nominals verification, the tolerance verification, or the results verification.

8. The method according to claim 7, wherein the verification report is a single page.

9. The method according to claim 1, wherein the master file is generated by importing a print of the production part and extracting the dimensions, nominals and tolerances for the production part from the print.

10. The method according to claim 9, wherein the master file is encrypted.

11. The method according to claim 1, wherein the master file is loaded into a measuring device, and the measurement results file is received from the measuring device.

12. The method according to claim 1, wherein the master file and the measurement results file are provided in a common data format.

13. The method according to claim 12, wherein the common data format is an XML data format.

14. A system for streamlining a production parts approval process, the system comprising:
a measuring device that measures dimensions of a production part; and
a computing system including a central processing unit configured to:
receive a master file, the master file including nominals and tolerances of the production part for a plurality of dimensions of the production part;
receive a measurement results file from the measuring device, the measurements results file containing results of measurements taken on the production part; and
create a verification report, the verification report including a summary of a comparison of the measurement results file with the master file.

15. The system according to claim 14, wherein:
the central processing unit is further configured to:
verify that, for every dimension of the product part in the master file, there is a corresponding measurement result in the measurement results file;
verify that the nominals for every dimension of the production part in the master file match the nominals for corresponding measurement results in the measurement results file;
verify that the tolerances for every dimension of the production part in the master file match the tolerances for corresponding measurement results in the measurement results file; and
verify that the measurement results in the measurement results file for each dimension of the production part are within the tolerance of the nominal of the dimension; and
the verification report includes a summary of the verifications performed by the central processing unit.

16. The system according to claim 15, wherein the measuring device measures dimensions of the production part a second time when the verification report indicates that errors or discrepancies were found during the verifications performed by the central processing unit.

17. The system according to claim 14, wherein:
the master file is generated by importing a print of the production part and extracting the dimensions, nominals and tolerances for the production part from the print;
the master file is loaded into the measuring device; and
the measuring device performs measurement of the production part based on the loaded master file.

18. A non-transitory computer readable storage medium storing instructions for streamlining a production parts approval process, the instructions causing a computing system to perform a method comprising:
receiving a master file, the master file including nominals and tolerances of a production part for a plurality of dimensions of the production part;
receiving a measurement results file containing results of measurements taken on the production part; and
creating a verification report, the verification report including a summary of a comparison of the measurement results file with the master file.

19. The storage medium according to claim 18, wherein:
the verification report includes a summary of: (1) a feature verification; (2) a nominals verification; (3) a tolerance verification; or (4) a results verification;
the feature verification includes verifying that, for every dimension of the product part in the master file, there is a corresponding measurement result in the measurement results file;
the nominals verification includes verifying that the nominals for every dimension of the production part in the master file match the nominals for corresponding measurement results in the measurement results file;
the tolerance verification includes verifying that the tolerances for every dimension of the production part in the master file match the tolerances for corresponding measurement results in the measurement results file; and
the results verification includes verifying that the measurement results in the measurement results file for each dimension of the production part are within the tolerance of the nominal of the dimension.

20. The storage medium according to claim 19, wherein the verification report further includes a single page summary of any errors or discrepancies found during the feature verification, the nominals verification, the tolerance verification, or the results verification.
